(19) United States
(12) Patent Application Publication
(10) Pub. No.: US 2025/0249558 A1
(43) Pub. Date: Aug. 7, 2025

(54) Magnetic Bit Holder

(71) Applicant: Snap-on Incorporated, Kenosha, WI (US)

(72) Inventors: Nicholas A. Gabbey, Mount Pleasant, WI (US); George R.R. Call, Kenosha, WI (US); Jonathan I. Andersen, Kenosha, WI (US)

(21) Appl. No.: 18/433,386

(22) Filed: Feb. 5, 2024

(51) Int. Cl. B25B 23/00; B25B 23/12

(52) U.S. Cl. CPC B25B 23/0035; B25B 23/12

(57) ABSTRACT

A magnetic bit holder includes a ring magnet surrounding an axis of rotation of the magnetic bit holder. A first connector is fixed with respect to the ring magnet and positioned along the axis of rotation on a first side of the ring magnet. The first connector is operable to secure to a tool along the axis of rotation. A solid shaft of non-ferrous material extends through the ring magnet. A second connector is positioned along the axis of rotation on a second side of the ring magnet. The second connector is operable to hold a tool bit.

### BACKGROUND

A bit holder is a versatile device that allows various tool bits to be removably attached to a shaft of a rotatable tool. The bit holder is secured to the shaft of the tool and transfers torque from the shaft to a tool bit that is held by the bit holder. A fastener is susceptible to falling off a bit and becoming a foreign object in a machine or work area where the tool is being used. This can result in lost time trying to locate and retrieve the fastener, or failure of a component if the foreign object is not removed.

### OVERVIEW

In an embodiment, a magnetic bit holder is disclosed. The magnetic bit holder includes a ring magnet surrounding an axis of rotation of the magnetic bit holder. A first connector is fixed with respect to the ring magnet and is positioned along the axis of rotation on a first side of the ring magnet. The first connector is operable to secure to a tool along the axis of rotation. The magnetic bit holder also includes a solid shaft of non-ferrous material extending through the ring magnet, and a second connector positioned along the axis of rotation on a second side of the ring magnet. The second connector is operable to hold a tool bit.

In an embodiment of the magnetic bit holder, the second connector and the solid shaft are formed in a single integral piece.

In an embodiment of the magnetic bit holder, the solid shaft is received in a second end of a base, and the first connector is formed as a female socket in a first end of the base.

In an embodiment of the magnetic bit holder, the ring magnet is attached to the second end of the base.

In an embodiment of the magnetic bit holder, the magnetic bit holder further includes a non-ferrous sleeve surrounding the ring magnet and the base.

In an embodiment of the magnetic bit holder, the solid shaft is removable from the base.

In an embodiment of the magnetic bit holder, the first connector, second connector, and solid shaft are part of a base that is formed in a single integral piece.

In an embodiment of the magnetic bit holder, the ring magnet extends around a middle portion of the base.

In an embodiment of the magnetic bit holder, the first connector is a female connector.

In an embodiment of the magnetic bit holder, the first connector is a male connector.

In an embodiment of the magnetic bit holder, the second connector is a bit socket.

In another embodiment, an apparatus is disclosed. The apparatus includes a tool comprising a rotatable shaft having an axis of rotation, a magnetic bit holder, and a bit formed of a ferrous material. The magnetic bit holder includes a first connector coupled to the rotatable shaft of the tool, and a ring magnet surrounding the axis of rotation. The ring magnet is fixed with respect to the first connector such that the first connector is positioned along the axis of rotation on a first side of the ring magnet. A solid shaft of non-ferrous material extends through the ring magnet. A second connector is positioned along the axis of rotation on a second side of the ring magnet. The bit is coupled to the second connector.

In an embodiment of the apparatus, the apparatus further includes a fastener magnetically coupled to an end of the bit.

In an embodiment of the apparatus, the first connector and the solid shaft of the magnetic bit holder are formed in a single integral piece.

In an embodiment of the apparatus, the solid shaft is received in a first end of a base, and the second connector is formed as a female socket in a second end of the base.

In an embodiment of the apparatus, the solid shaft is removable from the base.

In an embodiment of the apparatus, the first connector, second connector, and solid shaft are part of a base that is formed in a single integral piece.

In an embodiment of the apparatus, the ring magnet extends around a middle portion of the base

In another embodiment, a method of retaining a fastener on the end of a bit is disclosed. The method includes coupling a magnetic bit holder to a rotatable shaft of a tool. The magnetic bit holder includes a first connector coupled to the rotatable shaft of the tool and a ring magnet surrounding an axis of rotation of the shaft. The ring magnet is fixed with respect to the first connector such that the first connector is positioned along the axis of rotation on a first side of the ring magnet. The magnetic bit holder also includes a solid shaft of non-ferrous material extending through the ring magnet, and a second connector positioned along the axis of rotation on a second side of the ring magnet. The method also includes coupling a bit to the second connector, and securing a fastener to the bit such that a magnetic field of the ring magnet applies a retaining force on the fastener to hold the fastener against the bit.

In an embodiment of the method, the method further includes rotating the shaft of the tool.

In another embodiment an angled apparatus is disclosed. The apparatus includes a magnetic bit holder and an offset shaft. The magnetic bit holder includes a ring magnet surround an axis of rotation of the magnetic bit holder and a non-ferrous body. The non-ferrous body includes a solid shaft that extends through the ring magnet, a base positioned on a first side of the ring magnet along the axis of rotation of the magnetic bit holder, and a connector positioned along the axis of rotation on a second side of the ring magnet. The connector is operable to hold a tool component. The offset shaft is coupled to the base of the non-ferrous body. The offset shaft is operable to turn the magnetic bit holder and extends along an offset axis that is at an angle to the axis of rotation of the magnetic bit holder.

In an embodiment of the angled apparatus, the tool component is a bit socket.

In an embodiment of the angled apparatus, the offset shaft is configured to rotate about the offset axis to turn the magnetic bit holder.

In an embodiment of the angled apparatus, the offset shaft is coupled to the base of the non-ferrous body via angled gears.

In an embodiment of the angled apparatus, the offset shaft is configured to rotate around the axis of rotation of the magnetic bit holder to turn the magnetic bit holder.

In an embodiment of the angled apparatus, the offset shaft is coupled to the base of the non-ferrous body via a ratchet.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1A shows a perspective view of a magnetic bit holder in accordance with an example embodiment.

FIG. 1B shows an exploded view of the parts that form the magnetic bit holder of FIG. 1A.

FIG. 1C shows cross-sectional side view of the magnetic bit holder of FIG. 1A.

FIG. 2 shows a side view of a magnetic bit holder in accordance with another example embodiment and magnetic field lines of the magnetic bit holder.

FIG. 3 shows a side view of an alternative magnetic bit holder and magnetic field lines of the alternative magnetic bit holder.

FIG. 4A shows a side view of a magnetic bit holder in accordance with another example embodiment.

FIG. 4B shows a cross-sectional view of the magnetic bit holder of FIG. 4A.

FIG. 5A shows a side view of a magnetic bit holder in accordance with another example embodiment.

FIG. 5B shows a cross-sectional view of the magnetic bit holder of FIG. 5A.

FIG. 6 shows a cross-sectional view of an apparatus according to an example embodiment.

FIG. 7A shows a side view of an apparatus including a magnetic bit holder in accordance with an example embodiment.

FIG. 7B shows a cross-sectional view of the apparatus of FIG. 7A.

FIG. 8A shows a side view of another apparatus including a magnetic bit holder in accordance with an example embodiment.

FIG. 8B shows a cross-sectional view of the apparatus of FIG. 8A.

The drawings are schematic and not necessarily to scale. In the drawings, similar symbols typically identify similar components, unless context dictates otherwise.

### DETAILED DESCRIPTION

### I. Introduction

This description describes several example embodiments, at least some of which pertain to bit holders, such as magnetic bit holders. Bit holders are used to secure tool bits to the driven shafts of rotating or rotatable tools, such as drills and screwdrivers. One end of the bit holder is secured to the shaft of the tool and the other end holds a tool bit, for example in a bit socket. The bit holder transfers torque from the shaft to the secured tool bit, which allows the tool to be used with various different tool bits.

A magnetic bit holder may include a magnet that helps retain fasteners made of a ferrous material on the tool bit. The bit holder includes a magnet, and the magnetic field of the magnet exerts a force on the fastener holding it against the tool bit. This retaining force is particularly useful for overcoming the force of gravity, so that the fastener may be held against the bit without the need for a person to hold the fastener in place. Accordingly, the tool, with the fastener secured to the bit, can be inserted into tight positions that do not provide adequate space for a hand to hold the fastener in place. Once the fastener is secured in place, the retaining force generated by the magnet can be easily overcome by retracting the tool, and the tool bit can be removed from the fastener.

### II. Example Magnetic Bit Holders

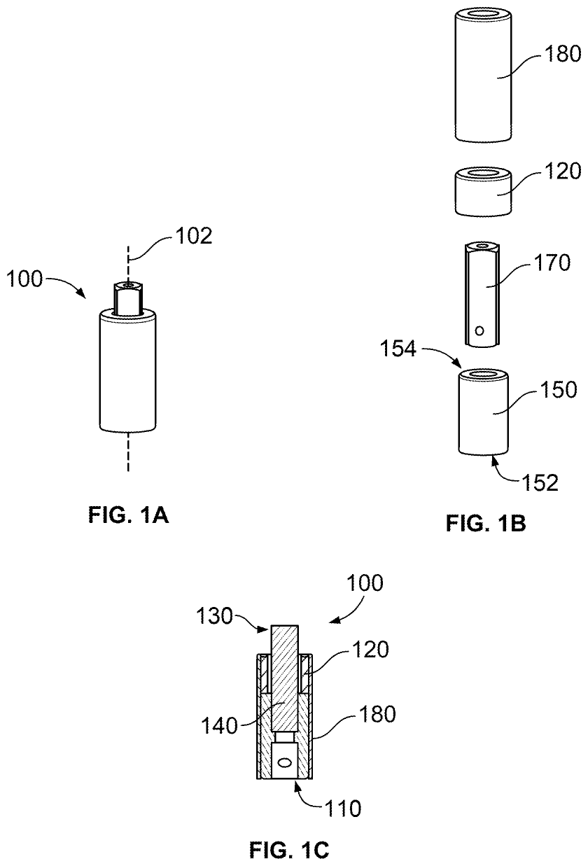

FIGS. 1A-1C show an embodiment of a magnetic bit holder 100. The magnetic bit holder 100 includes several elements that are formed by an apparatus of different pieces. As shown in the cross-sectional view of FIG. 1C, the magnetic bit holder 100 includes a first connector 110 that is operable to be secured to a tool, a ring magnet 120 that surrounds an axis of rotation 102 of the magnetic bit holder 100, a second connector 130 operable to hold a tool bit, and a solid shaft 140 of non-ferrous material that extends through the ring magnet 120. The first connector 110 is disposed on one side of the ring magnet 120, while the second connector 130 is disposed on the opposing side of the ring magnet 120. Accordingly, when the first connector 110 is coupled to a tool and the second connector 130 is coupled to a tool bit, the magnetic bit holder 100 can transfer torque from the tool to the tool bit and any fastener attached to the tool bit.

As shown in FIG. 1B, the magnetic bit holder 100 is formed by several distinct pieces. The second connector 130 is formed as a male shank at the end of a shaft component 170 that also forms the solid shaft 140 extending through the ring magnet 120. The shaft component 170 is received in a second end 154 of a base 150. The opposing first end 152 of the base 150 provides the first connector 110, which is in the form of a female socket for coupling to a tool. The ring magnet 120 is a distinct piece that is attached to the second end 154 of the base 150. A sleeve 180 of non-ferrous material surrounds both the ring magnet 120 and the base 150.

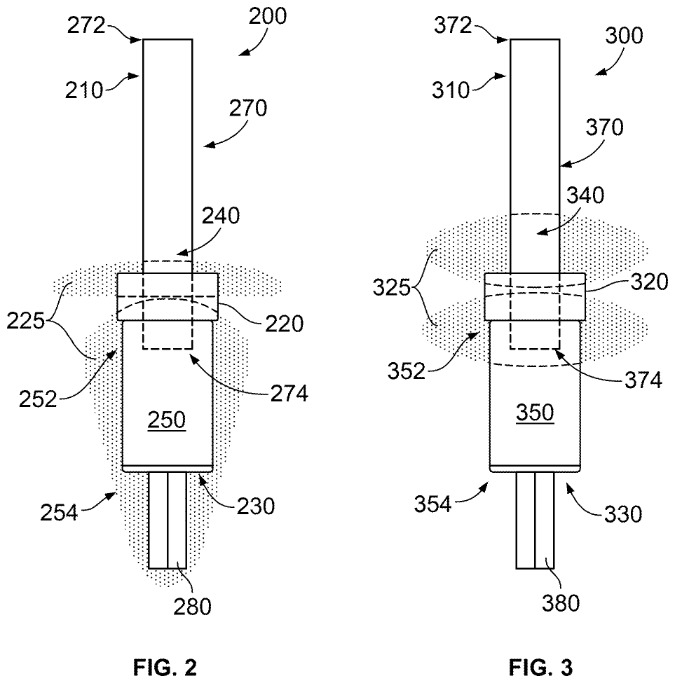

The inclusion of a solid shaft of non-ferrous material extending through the ring magnet helps direct the magnetic field of the ring magnet toward the tip of a tool bit held by the second connector. This phenomenon is illustrated by FIGS. 2 and 3. FIG. 2 shows a magnetic bit holder 200. A base 250 includes a receptacle in a first end 252 for receiving a shaft component 270. A proximal end 272 of the shaft component 270 includes a shank that provides a first connector 210 for the magnetic bit holder 200. For example, the shank 210 may be held in the chuck of a drill. The distal end of 274 of the shaft component 270 is held in the receptacle of the base 250. The opposing second end 254 of the base 250 includes a female socket that provides a second connector 230 for the magnetic bit holder 200. A ring magnet 220 is attached to the first end 252 of the base 250. The solid shaft 240 of the shaft component 270 passes through the ring magnet 220.

FIG. 3 shows a magnetic bit holder 300 with a nearly identical structure to magnetic bit holder 200 of FIG. 2. A base 350 includes a receptacle at a first end 352 and a female bit socket 330 at a second end 354. The receptacle in the first end 352 receives a distal end 374 of a shaft component 370 while a proximal end 372 of the shaft component 370 forms a shank that provides a first connector 310 for the magnetic bit holder 300. The female socket at the second end 354 of the base 350 provides a second connector 330 for the magnetic bit holder 300. A ring magnet 320 is attached to the first end 352 of the base 350. The solid shaft 340 of the shaft component 370 passes through the ring magnet 320.

The magnetic bit holder 200 of FIG. 2 and the magnetic bit holder 300 of FIG. 3 differ in that the shaft component 270 of magnetic bit holder 200 is formed of a non-ferrous material, while the shaft component 370 of magnetic bit holder 300 is formed of a ferrous material. As shown in FIG. 2, when a tool bit 280 formed of a ferromagnetic material is held in the bit socket 230, the magnetic field 225 of the ring magnet 220 is directed toward the tool bit 280. Using a non-ferrous solid shaft 240 extending through the ring magnet 220 maintains the magnetic field 225 directed toward the tool bit 280, and may direct the magnetic field to the tip of the tool bit 280. In contrast, as shown in FIG. 3, when the shaft component 370 is formed of a ferrous material, the solid shaft 340 of ferrous material passing through the ring magnet 320 redirects the magnetic field 325 to a more symmetrical shape and away from the tip of the tool bit 380.

In some embodiments, the second connector and the solid shaft are formed in a single integral piece. For example, in magnetic bit holder 100, as shown in FIGS. 1B and 1C, the solid shaft 140 and second connector 130 are both part of the shaft component 170, which is formed in a single integral piece. Forming the solid shaft and second connector in a single piece may reduce the total number of parts used in the magnetic bit holder and simplify assembly. In other embodiments, the second connector and the solid shaft that extends through the magnet are formed by separate pieces. For example, in some embodiments, the solid shaft extends through the ring magnet and is attached to a separate part that forms the connector for attachment to a tool bit, i.e., the second connector. In such an embodiment, the solid shaft and the second connector may be formed of different materials or the same material. Using separate pieces for the solid shaft and second connector may allow various manufacturing methods that might not be available with a single piece. Further, using separate materials for the solid shaft and second connector may allow these components to have different properties based on their uses.

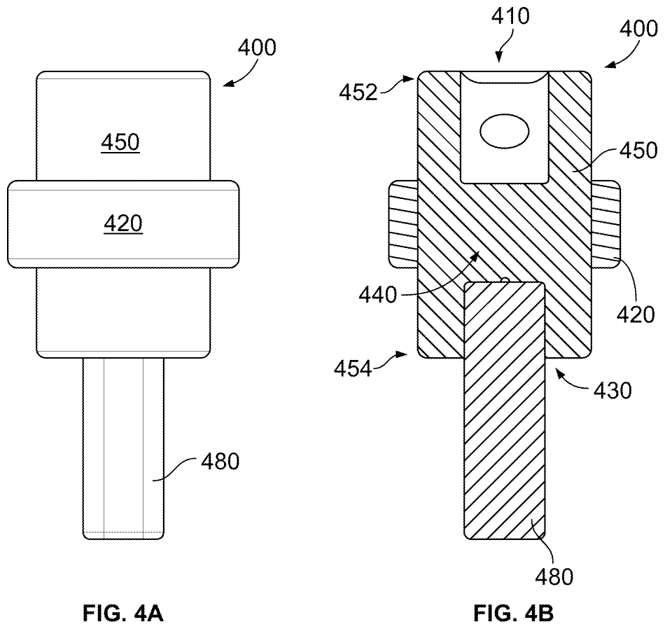

In some embodiments, the ring magnet is attached to an end of the base. For example, in magnetic bit holder 100 the ring magnet 120 is secured to the second end 154 of the base 150, while in magnetic bit holder 200, the ring magnet 220 is secured to the first end 252 of the base 250. In both cases, the solid shaft of non-ferrous material passes through the ring magnet and into the base. In other embodiments, the ring magnet may extend around the base. Such an embodiment is shown in FIGS. 4A and 4B and described in more detail below. Further, in some embodiments, the ring magnet may be incorporated into the base. For example, in some embodiments, the base may be formed of a ferrous material and the ring magnet may be located in the base.

In some embodiments, the first connector, second connector, and solid shaft are part of a base that is formed in a single integral piece. For example, FIGS. 4A and 4B illustrate such an embodiment. Magnetic bit holder 400, shown in FIG. 4B, includes a base 450 of a non-ferrous material. The base 450 includes a first connector 410, in the form of a female socket, in a first end 452 of the base 450. The base 450 also includes a second connector 430, in the form of a bit socket, in the second end 454 of the base 450. Between the first connector 410 and the second connector 430, the base 450 forms a solid shaft 440 of the non-ferrous material.

The magnetic bit holder 400 also includes a ring magnet 420 that extends around the outer perimeter of the base 450. Specifically, the ring magnet 420 is positioned at a middle portion of the base 450, such that the section of the base 450 that forms the solid shaft 440 passes through the ring magnet 420. Accordingly, the magnetic field of the ring magnet 420 may be directed to the tip of a bit 480 held in the second connector 430, which may help increase the holding force on any fastener secured to the bit.

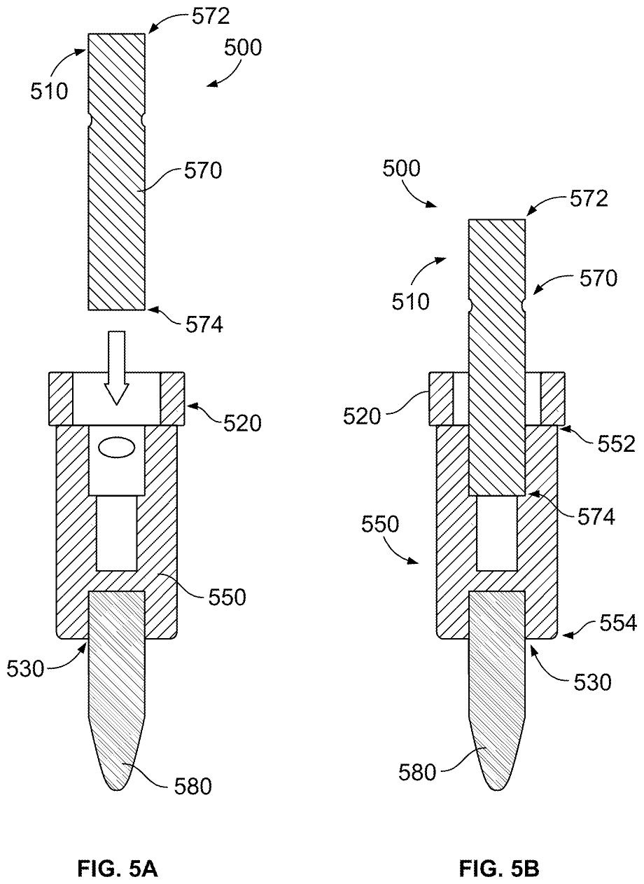

In some embodiments, the solid shaft is removable from the base. Such an embodiment is shown in FIGS. 5A and 5B. Magnetic bit holder 500 includes a base 550 that has a receptacle in a first end 552 for receiving a distal end 574 of a shaft component 570. The first end 552 of the base 550 is attached to a ring magnet 520. As shown in FIG. 5A, the shaft component 570 is removable from the base 550, but may be passed through the ring magnet 520 and inserted into the receptacle, as shown in FIG. 5B. A proximal end 572 of the shaft component 570 includes a first connector 510 in the form of a shank for attachment to a rotatable tool, such as a drill. The opposing second end 554 of the base 550 includes a bit socket that provides a second connector 530. FIGS. 5A and 5B also show a tool bit 580 held in the second connector 530.

In various embodiments, the magnetic bit holder may include a base formed of a ferrous material or a non-ferrous material. For example, in magnetic bit holder 500, shown in FIG. 5, the base 550 is formed of a ferrous material, and the shaft component 570 of non-ferrous material is inserted into the base 550. In contrast, in magnetic bit holder 400, shown in FIGS. 4A and 4B, the base 450 is formed of a non-ferrous material, for example titanium, stainless steel, or plastic.

The first connector of the magnetic bit holder of the disclosure may have various configurations. In some embodiments, the first connector is a male connector, such as a shank that is received by a rotatable tool. For example, the shank may be received in a chuck of a drill. In other embodiments, the first connector may be a female connector, such as a socket.

The first and second connectors may also have any of a range of sizes, whether male or female, including ¼ inch, ⅜ inch, ½ inch, ¾ inch, 1 inch, or other sizes. Further, the first and second connectors may have different shapes, such as square, hex, round, or another shape.

In some embodiments, the second connector is entirely disposed on one side of the ring magnet. As a result, a tool bit that is held in the bit socket is able to extend outward from the magnetic bit holder. This differs from many magnetic bit sockets, where a ring magnet may be configured to be positioned in the immediate vicinity of the tip of the bit. Such placement of the ring magnet so close to the bit tip may hinder maneuverability of the bit and limit its use with certain fasteners. In contrast, with the bit extending outward from magnetic bit holder and the ring magnet spaced from the bit, the illustrated magnetic bit holders can be used in a broader range of position and with a greater variety of fasteners.

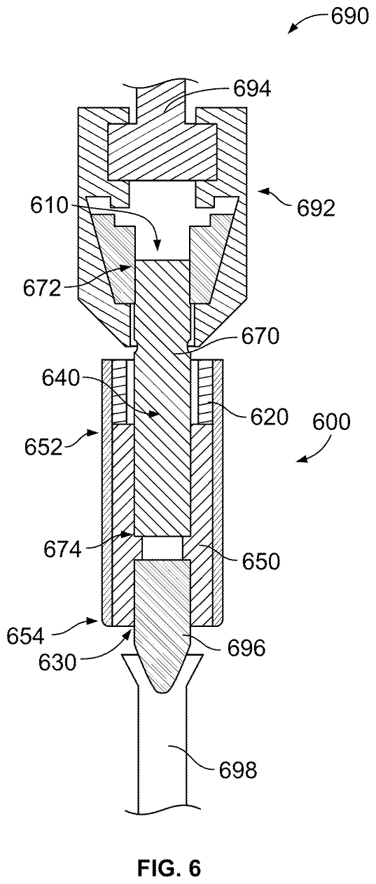

In another aspect, the disclosure provides an apparatus including a tool, a magnetic bit holder according to the disclosure that is secured to the tool, and a tool bit secured to the magnetic bit holder. Such an apparatus is shown in FIG. 6. Apparatus 690 includes a tool 692 including a rotatable shaft 694. A chuck is disposed on the end of the rotatable shaft 694 to secure a magnetic bit holder 600 to the rotatable shaft 694 of the tool 692. In the illustrated embodiment, the magnetic bit holder 600 includes a first connector 610 that has a male configuration, which is received in a receptacle of the tool 692. In other embodiments, however, the first connector of the magnetic bit holder may be female, and the tool may include a shaft that is received in the magnetic bit holder.

The first connector 610 of magnetic bit holder 600 is part of a shaft component 670 that is received in a base 650. Specifically, the base 650 includes a receptacle in a first end 652 for receiving the shaft component 670. A proximal end 672 of the shaft component 670 includes a shank that provides a first connector 610 for the magnetic bit holder 600. For example, the shank 610 may be held in the chuck of a drill. The distal end of 674 of the shaft component 670 is held in the receptacle of the base 650. The opposing second end 654 of the base 650 includes a female socket that provides a second connector 630 for the magnetic bit holder 600. A ring magnet 620 is attached to the first end 652 of the base 650. The solid shaft 640 of the shaft component 670 passes through the ring magnet 620.

The apparatus 690 also includes a bit 696 formed of a ferrous material that is coupled to the second connector 630 of the magnetic bit holder 600. The bit 696 is held in the socket that forms the second connector 630 in such a manner so as to transfer torque from the magnetic bit holder 600 to the bit 696. For example, the socket 630 and bit 696 may be a hex or square connection to allow the transfer of torque.

The bit may have various different forms for rotating a fastener or other piece that is worked on using the tool, including Torx, Phillips, internal hex, flat head, triple square, star, or other common bit configurations.

The tool of the apparatus may be a motorized tool, such as an electric drill or driver, an impact driver, an impact wrench, or another motorized rotating tool. Alternatively, the tool may be a hand tool, such as a screwdriver, a hand driver, a ratchet wrench, a manual drill, or another hand driven tool.

In some embodiments, the apparatus also includes a fastener magnetically coupled to an end of the bit. For example, apparatus 690 includes a fastener 698 that is secured to the bit 696. The fastener may have a corresponding head configuration as the bit, in order to securely fit on the bit.

In another aspect, the disclosure provides a method of retaining a fastener on the end of a bit. For example, as shown in FIG. 6, in view of the solid shaft 640 passing through the ring magnet 620 of the magnetic bit holder 600, the magnetic field of the ring magnet is directed to the tip of the bit 646 such that the fastener 698, which is formed of a ferrous material, may be retained against the bit 696 by a magnetic field of the ring magnet 620.

Further, in some embodiments, the method includes rotating the shaft of the tool. For example, rotating the shaft 694 of tool 692, the torque from the shaft 694 is transferred to the magnetic bit holder 600. In turn, the torque is transferred from magnetic bit holder 600 to the bit 696 and fastener 698 to either drive or remove the fastener 698 from a structure.

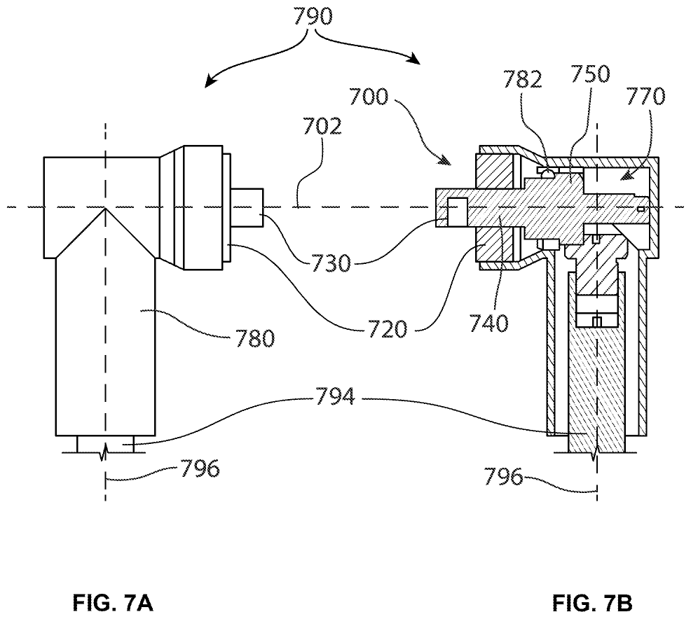

In another aspect, the disclosure provides an angled apparatus including an offset shaft coupled to a magnetic bit holder. FIGS. 7A and 7B show an embodiment of such an angled apparatus. FIG. 7A is a side view of apparatus 790, while FIG. 7B is a cross-sectional side view of apparatus 790 viewed from the opposite side. Apparatus 790 includes a magnetic bit holder 700 and an offset shaft 794 that is coupled to the magnetic bit holder 700. In apparatus 790 the offset shaft 794 functions as a drive shaft to rotate the magnetic bit holder 700.

The magnetic bit holder 700 includes a body 770 that rotates about an axis of rotation 702 for turning a tool component. A portion of the body 770 is surrounded by a ring magnet 720 that extends around the axis of rotation 702. In particular, the body 770 includes a solid shaft 740 of non-ferrous material that extends along the axis of rotation 702 and through the ring magnet 720. On one side of the ring magnet 720 along the axis of rotation 702, the body 770 includes a base 750 that is attached to a first end of the solid non-ferrous shaft 740. A connector 730 that is operable to hold a tool component is disposed on the opposite side of the ring magnet 720 along the axis of rotation 702.

In some embodiments, the connector 730 is a male connector, as shown, and is configured to fit into a receptacle of a tool component, such as the driven end of a bit socket. In other embodiments, the connector is a female connector and is configured to receive a tool component, such as a tool bit.

The offset shaft 794 extends along an offset axis 796 and may be coupled to the body 770 of the magnetic bit holder 700 through an angled gear configuration. For example, gear teeth may be provided around the base 750 of the body 770 of the magnetic bit holder 700. Such gear teeth may be integrally formed in the base 750, formed on a ring that extends around the base 750, or formed on a separate gear that is attached to the base 750. The angled gear configuration allows the rotation of the magnetic bit holder 700 about the axis of rotation 702 to be driven by the rotation of the offset-shaft 794 about its own axis. This angle drive configuration allows the apparatus 790 to fit into tight spaces and rotate the tool component while the apparatus stays in place.

The angled gear configuration can use a variety of different gear types, including bevel gears, right angle gears, screw gears, worm gears or others. Further, while the illustrated configuration includes the offset axis 796 as perpendicular to the axis of rotation 702 of the magnetic bit holder 700, in other embodiments, the offset axis of the offset shaft may be disposed at a different angle to the axis of oration of the magnetic bit holder.

The apparatus 700 also includes a housing 780 that holds the magnetic bit holder 700 and offset shaft 794 together. For example, magnetic bit holder 700 is held within the housing 780 by a bearing 782. The offset shaft 794 may be similarly held within the housing by a bearing or bushing.

In some embodiments, the ring magnet 720 is fixed on the body 770 and rotates with the body 700. In other embodiments, the ring magnet 720 may be held in place around the body 770 and allow the body 770 to rotate with respect to the ring magnet 720. For example, the ring magnet 720 may be secured directly to the housing 780, while the body 770 is coupled to the housing 780 via the bearing 782.

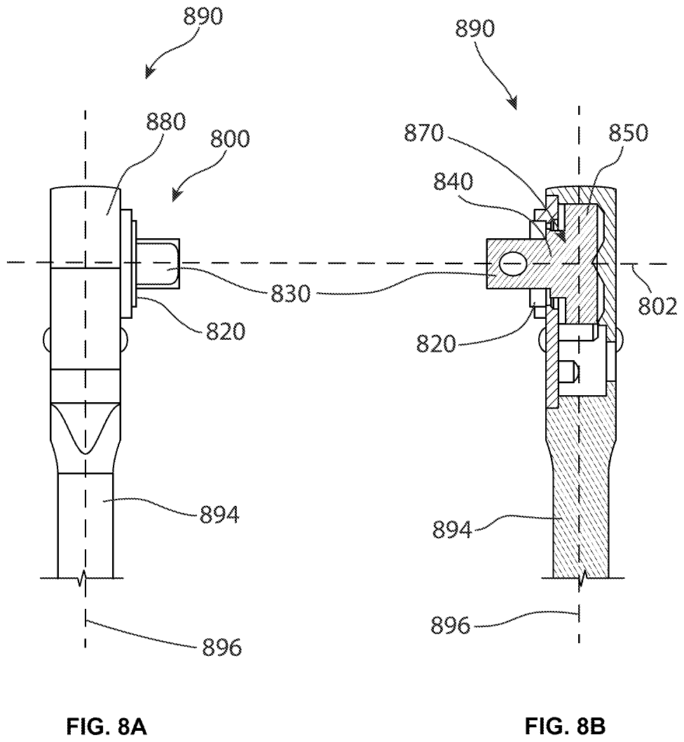

FIGS. 8A and 8B illustrate another embodiment of an angled apparatus with an offset shaft coupled to a magnetic bit holder. FIG. 8A is a side view of apparatus 890, while FIG. 8B is a cross-sectional side view of apparatus 890 viewed from the opposite side. Apparatus 890 includes a magnetic bit holder 800 and an offset shaft 894 that is coupled to the magnetic bit holder 800.

The magnetic bit holder 800 includes a body 870 that rotates about an axis of rotation 802 for turning a tool component. A ring magnet 820 surrounds the axis of rotation 802 and a portion of the body 870, such that the body 870 extends through the ring magnet 820 and opposing ends of the body 870 are positioned on either side of the ring magnet 820 along the axis of rotation 802. The portion of the body 870 that extends through the ring magnet 820 is formed by a solid shaft 840 of non-ferrous material. On one side of the ring magnet 820 along the axis of rotation 802, the body 870 includes a base 850. A connector 830 that is operable to hold a tool component is disposed on the opposite side of the ring magnet 820 along the axis of rotation 802. As in apparatus 700, the connector 830 of apparatus 800 may be a male connector or a female connector.

The offset shaft 894 extends along an offset axis 896 and, in the illustrated embodiment, forms a handle that turns the magnetic bit holder 800 by rotating around the axis of rotation 802, such as with a wrench. Such a construction allows the magnetic bit holder of the disclosure to be utilized in tools such as wrenches.

The offset shaft 894 may be coupled to the body 870 of the magnetic bit holder 800 through a ratchet, such that the apparatus 800 forms a ratcheting tool. For example, teeth may be provided around the base 850 of the body 870 of the magnetic bit holder 800, and the apparatus may include a pawl that allows rotation of the base 850 in one direction but not the other. The ratcheting teeth may be integrally formed in the base 850, formed on a ring that extends around the base 850, or formed on a separate element that is attached to the base 850.

The apparatus 800 also includes a housing 880 that holds the magnetic bit holder 800 and offset shaft 894 together. In some embodiments, such as when the magnetic bit holder 800 and offset shaft 894 are coupled by a ratchet, the housing 880 may be configured to allow the magnetic bit holder 800 to rotate therein. For example, the magnetic bit holder 800 may be held within the housing 880 by a bearing. In other embodiments the magnetic bit holder may be fixed with respect to the housing. Further, in some embodiments, the housing 880 may be integrally formed with the offset shaft 894, while in other embodiments the housing and offset shaft may be coupled by a joint, such as with a swivel of flexible head ratchet.

While the illustrated configuration includes the offset axis 896 as perpendicular to the axis of rotation 802 of the magnetic bit holder 800, in other embodiments, the axis of the offset shaft may be disposed at a different angle to the axis of oration of the magnetic bit holder.

In some embodiments, the ring magnet 820 is fixed on the body 870 and rotates with the body 800. In other embodiments, the ring magnet 820 may be held in place around the body 870 and allow the body 870 to rotate with respect to the ring magnet 820.

The ring magnet of the disclosure is described as a “ring” because it forms a loop around an inner opening. Accordingly, the non-ferrous solid shaft may extend through the inner opening of the ring magnet. The ring magnet may have any of various shapes that form a loop that can extend around the solid shaft. For example, while the ring magnet may be circular as in the illustrated embodiments, the ring magnet may also be square, hexagonal, octagonal, another polygonal shape, oval, or have a complex shape that forms a ring around the solid shaft. In some embodiments, the ring magnet forms a closed loop that encircles the solid shaft.

The phrase “solid shaft” as used herein refers to a shaft with a core extending along the central axis of the shaft. The solid shaft is distinct from a hollow shaft, which may include a bore along its axis. The phrase “solid shaft” does not exclude shafts with grooves, dimples or other openings therein. Further, the phrase “solid shaft” does not limit the construction of the shaft to non-porous materials. Thus, a shaft including a core and without any axial bore may be formed of a porous material with internal voids should be understood as a solid shaft. Of course, in some embodiments, the solid shaft is non-porous.

Embodiments described herein may provide fastener retention on a tool bit by redirecting the magnetic field using a ferromagnetic material and may allow a connection to other tools without decreasing the magnetic field strength at the tip of the bit. This may decrease the chance of dropping the fastener when removing and installing a component.

Further, the magnetic bit adaptors described herein may allow more freedom with magnet size, thereby allowing a larger and stronger field, and may allow an unobstructed view of the fastener and location of install of the component. By locating the magnet at the base of the magnetic bit holder, the need to alter bit dimensions may be avoided, as the magnetic bit holder does not limit the space for installation or removal of the fastener, when compared to a sleeve style retention method.

Embodiments described herein may allow the bit to go from a magnetized state to non-magnetized state by adding or removing the bit holder. For instance when the bit is used in an area with loose metal particles, such particles may stick to a magnetized bit, which may prevent full insertion into the fastener. By removing the magnetic field, the removal of the metallic particles may become easier for each use, which may improve engagement.

### IV. Conclusion

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions. For example, an embodiment described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible embodiments: (i) an embodiment including A, but not B and not C, (ii) an embodiment including B, but not A and not C, (iii) an embodiment including C, but not A and not B, (iv) an embodiment including A and B, but not C, (v) an embodiment including A and C, but not B, (v) an embodiment including B and C, but not A, and/or (vi) an embodiment including A, B, and C. For the embodiments including component or function A, the embodiments can include one A or multiple A. For the embodiments including component or function B, the embodiments can include one B or multiple B. For the embodiments including component or function C, the embodiments can include one C or multiple C. In accordance with the aforementioned example and at least some of the example embodiments, “A” can represent a component, “B” can represent a system, and “C” can represent a symptom.

The use of ordinal numbers such as “first,” “second,” “third” and so on is to distinguish respective elements rather than to denote an order of those elements unless the context of using those terms explicitly indicates otherwise. Further, the description of a “first” element, such as a first plate, does not necessitate the presence of a second or any other element, such as a second plate.

Implementations of the present disclosure may thus relate to one of the enumerated example embodiments (EEEs) listed below.

EEE 1 is a magnetic bit holder comprising: a ring magnet surrounding an axis of rotation of the magnetic bit holder; a first connector fixed with respect to the ring magnet and positioned along the axis of rotation on a first side of the ring magnet, the first connector being operable to secure to a tool along the axis of rotation; a solid shaft of non-ferrous material extending through the ring magnet; and a second connector positioned along the axis of rotation on a second side of the ring magnet, the second connector being operable to hold a tool bit.

EEE 2 is the magnetic bit holder of EEE 1, wherein the second connector and the solid shaft are formed in a single integral piece.

EEE 3 is the magnetic bit holder of EEE 2, wherein the solid shaft is received in a second end of a base, and wherein the first connector is formed as a female socket in a first end of the base.

EEE 4 is the magnetic bit holder of EEE 3, wherein the ring magnet is attached to the second end of the base.

EEE 5 is the magnetic bit holder of any of EEEs 2 to 4, further comprising a non-ferrous sleeve surrounding the ring magnet and the base.

EEE 6 is the magnetic bit holder of any of EEEs 3 to 5, wherein the solid shaft is removable from the base.

EEE 7 is the magnetic bit holder of EEE 1, wherein the first connector, second connector, and solid shaft are part of a base that is formed in a single integral piece.

EEE 8 is the magnetic bit holder of EEE 7, wherein the ring magnet extends around a middle portion of the base.

EEE 9 is the magnetic bit holder of any of EEEs 1 to 8, wherein the first connector is a female connector.

EEE 10 is the magnetic bit holder of any of EEEs 1 to 8, wherein the first connector is a male connector.

EEE 11 is the magnetic bit holder of any of EEEs 1 to 10, wherein the second connector is a bit socket.

EEE 12 is an apparatus comprising: a tool comprising a rotatable shaft having an axis of rotation; a magnetic bit holder according to any of EEEs 1 to 11; and a bit formed of a ferrous material coupled to the second connector.

EEE 13 is the apparatus of EEE 12, further comprising a fastener magnetically coupled to an end of the bit.

EEE 14 is a method of retaining a fastener on the end of a bit, the method comprising: coupling a magnetic bit holder according to any of EEEs 1 to 11 to a rotatable shaft of a tool; coupling a bit to the second connector; and securing a fastener to the bit such that a magnetic field of the ring magnet applies a retaining force on the fastener to hold the fastener against the bit.

EEE 15 is the method EEE 14, further comprising rotating the shaft of the tool.

EEE 16 is an angled apparatus comprising: a magnetic bit holder comprising: a ring magnet surrounding an axis of rotation of the magnetic bit holder, and a non-ferrous body including a solid shaft that extends through the ring magnet, a base positioned on a first side of the ring magnet along the axis of rotation of the magnetic bit holder, and a connector positioned along the axis of rotation on a second side of the ring magnet, the connector being operable to hold a tool component; and an offset shaft coupled to the base of the non-ferrous body, wherein the offset shaft is operable to turn the magnetic bit holder and extends along an offset axis that is at an angle to the axis of rotation of the magnetic bit holder.

EEE 17 is the angled apparatus of EEE 16, wherein the tool component is a bit socket.

EEE 18 is the angled apparatus of EEE 16 or EEE 17, wherein the offset shaft is configured to rotate about the offset axis to turn the magnetic bit holder.

EEE 19 is the angled apparatus of any of EEES 16 to 18, wherein the offset shaft is coupled to the base of the non-ferrous body via angled gears.

EEE 20 is the angled apparatus of EEE 16 or EEE 17, wherein the offset shaft is configured to rotate around the axis of rotation of the magnetic bit holder to turn the magnetic bit holder.

EEE 21 is the angled apparatus of EEE 16, EEE 17, or EEE 20, wherein the offset shaft is coupled to the base of the non-ferrous body via a ratchet.

What is claimed is:

1. A magnetic bit holder comprising:
a ring magnet surrounding an axis of rotation of the magnetic bit holder;
a first connector fixed with respect to the ring magnet and positioned along the axis of rotation on a first side of the ring magnet, the first connector being operable to secure to a tool along the axis of rotation;
a solid shaft of non-ferrous material extending through the ring magnet; and
a second connector positioned along the axis of rotation on a second side of the ring magnet, the second connector being operable to hold a tool bit.

2. The magnetic bit holder of claim 1, wherein the second connector and the solid shaft are formed in a single integral piece.

3. The magnetic bit holder of claim 2, wherein the solid shaft is received in a second end of a base, and
wherein the first connector is formed as a female socket in a first end of the base.

4. The magnetic bit holder of claim 3, wherein the ring magnet is attached to the second end of the base.

5. The magnetic bit holder of claim 4, further comprising a non-ferrous sleeve surrounding the ring magnet and the base.

6. The magnetic bit holder of claim 3, wherein the solid shaft is removable from the base.

7. The magnetic bit holder of claim 1, wherein the first connector, second connector, and solid shaft are part of a base that is formed in a single integral piece.

8. The magnetic bit holder of claim 7, wherein the ring magnet extends around a middle portion of the base.

9. The magnetic bit holder of claim 1, wherein the first connector is a female connector.

10. The magnetic bit holder of claim 1, wherein the first connector is a male connector.

11. The magnetic bit holder of claim 1, wherein the second connector is a bit socket.

12. An apparatus comprising:
a tool comprising a rotatable shaft having an axis of rotation;
a magnetic bit holder comprising:
a first connector coupled to the rotatable shaft of the tool,
a ring magnet surrounding the axis of rotation and fixed with respect to the first connector such that the first connector is positioned along the axis of rotation on a first side of the ring magnet,
a solid shaft of non-ferrous material extending through the ring magnet, and
a second connector positioned along the axis of rotation on a second side of the ring magnet; and
a bit formed of a ferrous material coupled to the second connector.

13. The apparatus of claim 12, further comprising a fastener magnetically coupled to an end of the bit.

14. The apparatus of claim 12, wherein the first connector and the solid shaft of the magnetic bit holder are formed in a single integral piece.

15. The apparatus of claim 14, wherein the solid shaft is received in a first end of a base, and
wherein the second connector is formed as a female socket in a second end of the base.

16. The apparatus of claim 15, wherein the solid shaft is removable from the base.

17. The apparatus of claim 12, wherein the first connector, second connector, and solid shaft are part of a base that is formed in a single integral piece.

18. The apparatus of claim 17, wherein the ring magnet extends around a middle portion of the base.

19. An angled apparatus comprising:
a magnetic bit holder comprising:
a ring magnet surrounding an axis of rotation of the magnetic bit holder, and
a non-ferrous body including a solid shaft that extends through the ring magnet, a base positioned on a first side of the ring magnet along the axis of rotation of the magnetic bit holder, and a connector positioned along the axis of rotation on a second side of the ring magnet, the connector being operable to hold a tool component; and
an offset shaft coupled to the base of the non-ferrous body, wherein the offset shaft is operable to turn the magnetic bit holder and extends along an offset axis that is at an angle to the axis of rotation of the magnetic bit holder.

20. The angled apparatus of claim 19, wherein the tool component is a bit socket.

21. The angled apparatus of claim 19, wherein the offset shaft is configured to rotate about the offset axis to turn the magnetic bit holder.

22. The angled apparatus of claim 21, wherein the offset shaft is coupled to the base of the non-ferrous body via angled gears.

23. The angled apparatus of claim 19, wherein the offset shaft is configured to rotate around the axis of rotation of the magnetic bit holder to turn the magnetic bit holder.

24. The angled apparatus of claim 23, wherein the offset shaft is coupled to the base of the non-ferrous body via a ratchet.

25. A method of retaining a fastener on an end of a bit, the method comprising:
coupling a magnetic bit holder to a rotatable shaft of a tool, the magnetic bit holder comprising:
a first connector coupled to the rotatable shaft of the tool,
a ring magnet surrounding an axis of rotation of the shaft and fixed with respect to the first connector such that the first connector is positioned along the axis of rotation on a first side of the ring magnet,
a solid shaft of non-ferrous material extending through the ring magnet; and
a second connector positioned along the axis of rotation on a second side of the ring magnet;
coupling the bit to the second connector;
securing a fastener to the bit such that a magnetic field of the ring magnet applies a retaining force on the fastener to hold the fastener against the bit.

26. The method claim 25, further comprising rotating the shaft of the tool.
